(19) United States
(12) Patent Application Publication
(10) Pub. No.: US 2022/0312573 A1
(43) Pub. Date: Sep. 29, 2022

(54) ELECTRONIC DEVICE AND DRIVING METHOD

(71) Applicant: Midastek Microelectronics Inc., Taipei City (TW)

(72) Inventor: Chung-Ping Tan, Taipei City (TW)

(73) Assignee: Midastek Microelectronics Inc., Taipei City (TW)

(21) Appl. No.: 17/376,108

(22) Filed: Jul. 14, 2021

(30) Foreign Application Priority Data
Mar. 23, 2021 (TW) 110110406

(51) Int. Cl. H05B 47/16; H05B 45/37

(52) U.S. Cl. CPC H05B 47/16; H05B 45/37

(57) ABSTRACT

An electronic device and a driving method are provided. The electronic device includes a driving signal input terminal, a signal transmission terminal, a fan, a light-emitting element group, and a controller. The controller receives a first fan driving signal through the driving signal input terminal, and drives the fan by using the first fan driving. The controller provides a third fan driving signal to control an operation of the fan and provides a light-emitting driving signal string to drive the light-emitting element group based on a control signal when the first fan driving signal is converted into a second fan driving signal and the control signal is received through the signal transmission terminal.

### CROSS-REFERENCE TO RELATED APPLICATION

This application claims the priority benefit of Taiwanese application no. 110110406, filed on Mar. 23, 2021. The entirety of the above-mentioned patent application is hereby incorporated by reference herein and made a part of this specification.

### BACKGROUND

### Technical Field

The disclosure relates to an electronic device and a driving method; particularly, the disclosure relates to an electronic device and a driving method in which a fan and multiple light-emitting elements can be driven.

### Description of Related Art

With reference to FIG. 1A, which is a schematic diagram of a current electronic device, in addition to power source terminals PWR and GND, a current electronic device 10 includes a fan 11 and a light-emitting element group 12. The electronic device 10 receives a fan driving signal SD_FAN through an input terminal T1, and drives the fan 11 by the fan driving signal SD_FAN. The electronic device 10 outputs a feedback signal FG of the fan 11 through the output terminal T2. Besides, the electronic device 10 also receives a driving voltage V_LED and driving data D1, D2, and D3 for driving the light-emitting element group 12 through other input terminals T3 to T6. In FIG. 1A, the light-emitting element group 12 provide a light signal based on the driving data D1, D2, and D3 in an analog form. With reference to FIG. 1B, which is also is a schematic diagram of a current electronic device, unlike in FIG. 1A, a current electronic device 20 receives the driving voltage V_LED, a light-emitting driving signal string DS, and a reference low level voltage VR (e.g., a grounding voltage) for driving a light-emitting element group 22 through the input terminals T3 to T5. In FIG. 1B, the light-emitting element group 22 provides light signals based on the light-emitting driving signal string DS in a digital form.

In FIG. 1A, to effectively drive the fan 11 and the light-emitting element group 12, the electronic device 10 requires five input terminals T1 and T3 to T6. In FIG. 1B, to effectively drive a fan 21 and the light-emitting element group 22, the electronic device 20 requires four input terminals T1 and T3 to T5. It should be noted that more input terminals occupy more physical space. Therefore, how to effectively reduce the number of input terminals to reduce the size of the electronic device is one of the research focuses for those skilled in the art.

### SUMMARY

The disclosure provides an electronic device and a driving method, in which the number of input terminals of the electronic device can be reduced, thereby reducing the size of the electronic device.

According to an embodiment of the disclosure, an electronic device includes a driving signal input terminal, a signal transmission terminal, a fan, a light-emitting element group, and a controller. The light-emitting element group operates in response to a light-emitting driving signal string. The controller is coupled to the fan and the light-emitting element group. The controller receives a first fan driving signal through the driving signal input terminal and drives the fan by using the first fan driving signal. In addition, the controller provides a third fan driving signal to control an operation of the fan and provides the light-emitting driving signal string based on a control signal when the first fan driving signal is converted into a second fan driving signal and the control signal is received through the signal transmission terminal.

According to an embodiment of the disclosure, a driving method is applicable to an electronic device. The electronic device includes a driving signal input terminal, a signal transmission terminal, a fan, and a light-emitting element group. The driving method includes the following. A first fan driving signal is received through the driving signal input terminal and the fan is driven by using the first fan driving signal. In addition, a third fan driving signal is provided to control an operation of the fan and a light-emitting driving signal string is provided based on a control signal when the first fan driving signal is converted into a second fan driving signal and the control signal is received through the signal transmission terminal.

Based on the foregoing, in the disclosure, the electronic device is configured to receive the first fan driving signal through the driving signal input terminal. When the first fan driving signal is converted into the second fan driving signal and the control signal is received through the signal transmission terminal, the electronic device is configured to provide the third fan driving signal to control the operation of the fan and provide the light-emitting driving signal string. Therefore, the electronic device can drive the fan and the light-emitting element group by using merely the signals received through the driving signal input terminal and the signal transmission terminal. Therefore, in the electronic device and the driving method, the number of input terminals of the electronic device can be reduced, thereby reducing the size of the electronic device.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram of a current electronic device.

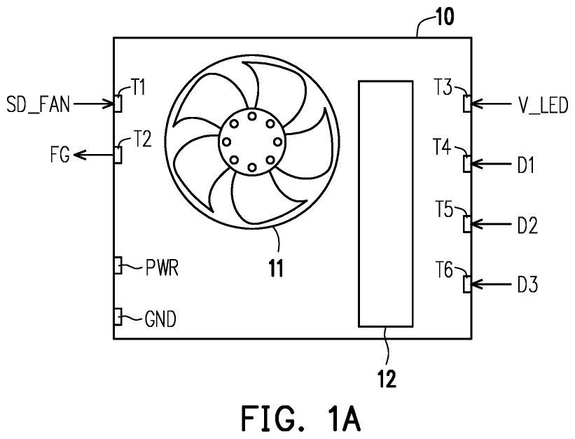

FIG. 1B is a schematic diagram of a current electronic device.

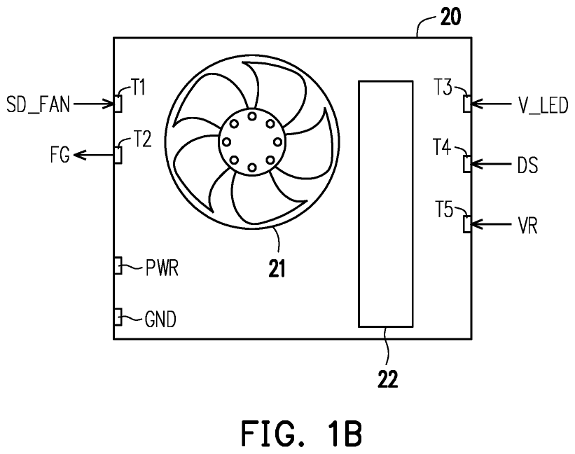

FIG. 2 is a schematic diagram showing an electronic device according to a first embodiment of the disclosure.

FIG. 3 is another schematic diagram showing the electronic device according to the first embodiment of the disclosure.

FIG. 4 is a flowchart showing a first method of a driving method according to an embodiment of the disclosure.

FIG. 5 is a flowchart showing a second method of a driving method according to an embodiment of the disclosure.

FIG. 6 is a signal timing diagram according to the first embodiment of the disclosure.

FIG. 7 is a schematic diagram of an electronic device according to a second embodiment of the disclosure.

FIG. 8 is a flowchart showing a third method of a driving method according to an embodiment of the disclosure.

FIG. 9 is a signal timing diagram according to the second embodiment of the disclosure.

### DESCRIPTION OF THE EMBODIMENTS

Hereinafter, some embodiments of the disclosure in accompany with the drawings will be provided for detailed description. For the reference numerals recited in the following description, when the same reference numerals are shown in different figures, these reference numerals are deemed to refer to the same or similar elements. These embodiments are only part of the disclosure and every implementation of the disclosure is not disclosed therein. More precisely, these embodiments are only exemplary examples of the claims of the disclosure.

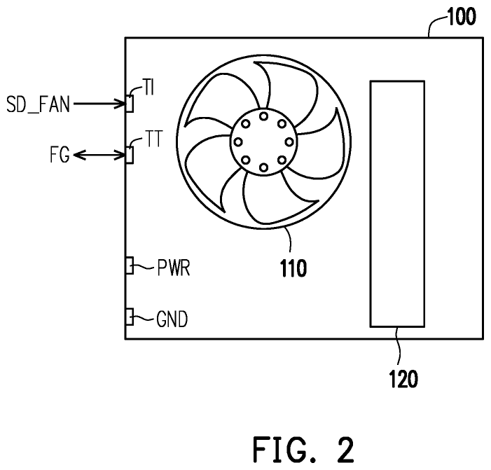

With reference to FIG. 2, which is a schematic diagram showing an electronic device according to a first embodiment of the disclosure, in this embodiment, an electronic device 100 can effectively control an operation of a fan 110 and an operation of a light-emitting element group 120 by using merely signals received through a driving signal input terminal TI and a signal transmission terminal TT. Therefore, the size of the electronic device may be reduced.

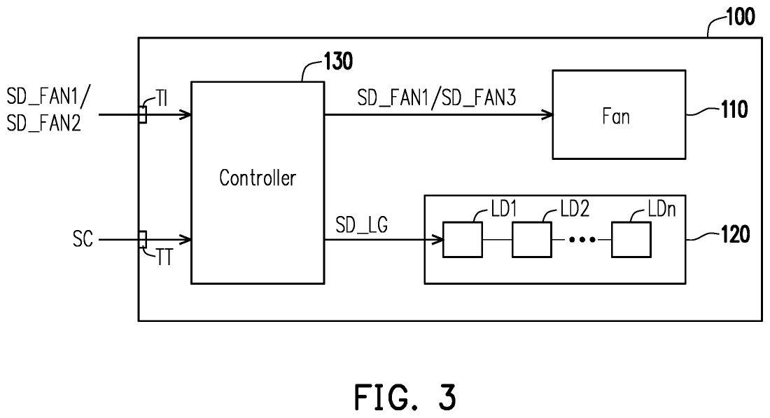

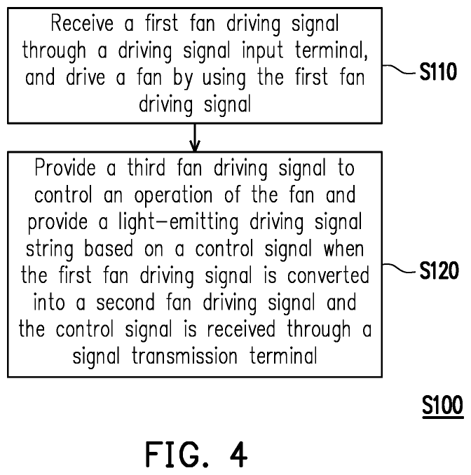

For specific description, reference may be made to FIG. 3 and FIG. 4 together. FIG. 3 is another schematic diagram showing the electronic device according to the first embodiment of the disclosure. FIG. 4 is a flowchart showing a first method of a driving method according to an embodiment of the disclosure. A driving method S100 of FIG. 4 may be applied to the electronic device 100 of FIG. 3. In this embodiment, the electronic device 100 includes the driving signal input terminal TI, the signal transmission terminal TT, the fan 110, the light-emitting element group 120, and a controller 130. In this embodiment, the fan 110 may be a conventionally known fan element in any form. In this embodiment, the light-emitting element group 120 includes a plurality of light-emitting elements LD1 to LDn. The light-emitting elements LD1 to LDn may each be realized by a light-emitting diode (LED), a micro LED, an organic LED (OLED), or any other element. In this embodiment, the light-emitting elements LD1 to LDn are connected in series with each other. Notably, with the light-emitting elements LD1 to LDn connected in series, the number of connection pins between the light-emitting element group 120 and the controller 130 may be reduced. In this embodiment, the light-emitting element group 120 operates in response to a light-emitting driving signal string SD_LG. The light-emitting driving signal string SD_LG includes a plurality of driving data corresponding to the light-emitting elements LD1 to LDn. For example, the light-emitting element LD1 may be driven by a first driving data, the light-emitting element LD2 may be driven by a second driving data, and so on. In some embodiments, the light-emitting element group 120 may include merely one single light-emitting element. In the disclosure, the number of and the connection between the light-emitting elements are not limited to this embodiment.

In this embodiment, the controller 130 is coupled to the fan 110 and the light-emitting element group 120. In step S110, the controller 130 receives a first fan driving signal SD_FAN1 through the driving signal input terminal TI, and drives the fan 110 by using the first fan driving signal SD_FAN1. That is to say, in step S110, the controller 130 drives the fan 110 by using the first fan driving signal SD_FAN1 received through the driving signal input terminal TI.

In step S120, when the first fan driving signal SD_FAN1 is converted into a second fan driving signal SD_FAN2 and a control signal SC is received through the signal transmission terminal TT, the controller 130 provides a third fan driving signal SD_FAN3 to control the operation of the fan 110 and provides the light-emitting driving signal string SD_LG based on the control signal SC. That is to say, in the case where the first fan driving signal SD_FAN1 is converted into the second fan driving signal SD_FAN2, based on the control signal SC received through the signal transmission terminal TT, the controller 130 provides the third fan driving signal SD_FAN3 and the light-emitting driving signal string SD_LG. In this embodiment, the controller 130 drives the fan 110 by using the third fan driving signal SD_FAN3 and drives the light-emitting element group 120 by using the light-emitting driving signal string SD_LG.

In this embodiment, the first fan driving signal SD_FAN1, the second fan driving signal SD_FAN2, and the third fan driving signal SD_FAN3 are each a pulse-width modulation (PWM) signal. Based on a duty cycle of one of the first fan driving signal SD_FAN1 and the third fan driving signal SD_FAN3, the fan 110 may provide a fan rotation speed corresponding to the duty cycle.

In this embodiment, the first fan driving signal SD_FAN1 and the second fan driving signal SD_FAN2 may be provided by a driving signal generating circuit, for example.

Notably, the electronic device 100 receives the first fan driving signal SD_FAN1 through the driving signal input terminal TI. When the control signal SC is received through the signal transmission terminal TT during a period when the first fan driving signal SD_FAN1 is converted into the second fan driving signal SD_FAN2, the electronic device 100 provides the third fan driving signal SD_FAN3 to drive the fan 110 and provides the light-emitting driving signal string SD_LG to drive the light-emitting element group 120. The electronic device 100 can drive the fan 110 and the light-emitting element group 120 by using merely the signals received through the driving signal input terminal TI and the signal transmission terminal TT. Therefore, in the electronic device 100 and the driving method S100 of this embodiment, the number of input terminals of the electronic device 100 can be effectively reduced, thereby reducing the size of the electronic device 100.

In this embodiment, the controller 130 is, for example, a central processing unit (CPU), or any other programmable general-purpose or special-purpose microprocessor, digital signal processor (DSP), programmable controller, application-specific integrated circuit (ASIC), programmable logic device (CPLD), or other similar devices or a combination of these devices, into which computer programs may be loaded and executed.

In this embodiment, the driving signal input terminal TI and the signal transmission terminal TT are disposed outside the controller 130 (e.g., disposed on a casing of the electronic device 100). In some embodiments, the driving signal input terminal TI and the signal transmission terminal TT are disposed on the controller 130.

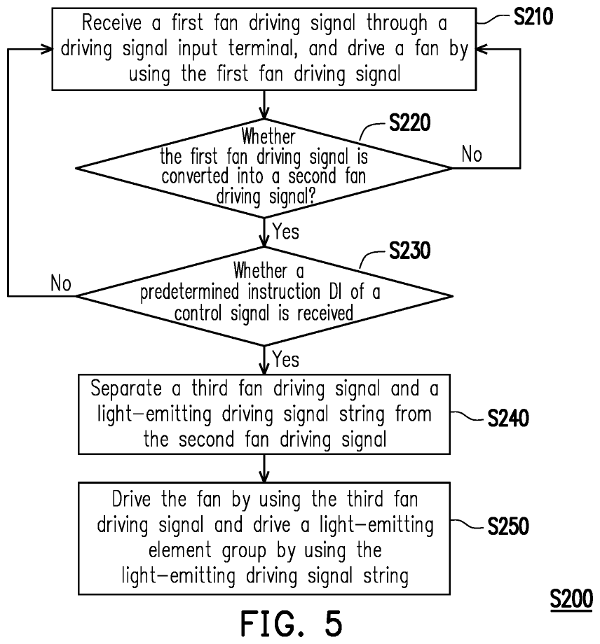

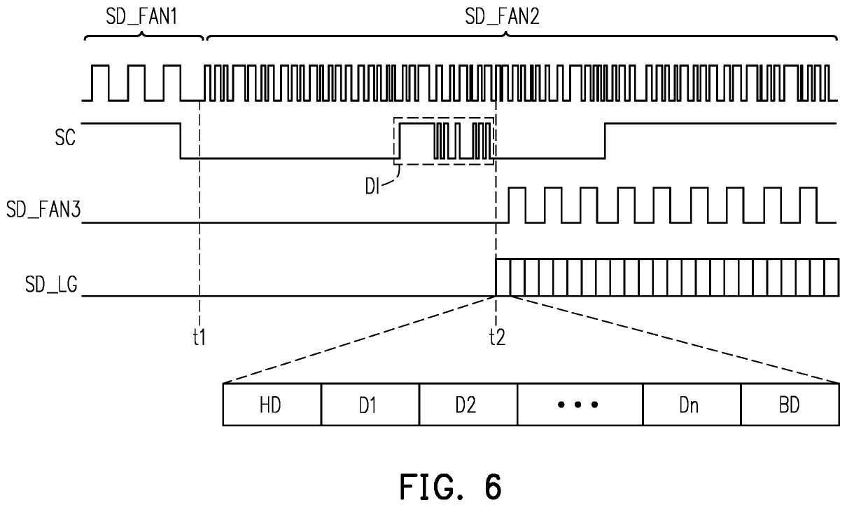

Reference may be made to FIG. 3, FIG. 5, and FIG. 6 together. FIG. 5 is a flowchart showing a second method of a driving method according to an embodiment of the disclosure. FIG. 6 is a signal timing diagram according to the first embodiment of the disclosure. A driving method S200 of FIG. 5 and the signal timing diagram of FIG. 6 may be applied to the electronic device 100 of FIG. 3. In step S210 of this embodiment, the controller 130 drives the fan 110 by using the first fan driving signal SD_FAN1. In step S220, the controller 130 determines whether the first fan driving signal SD_FAN1 is converted into the second fan driving signal SD_FAN2. In step S220, if the controller 130 determines that the first fan driving signal SD_FAN1 is not converted into the second fan driving signal SD_FAN2, the driving method S200 returns to step S210.

On the other hand, in step S220, if the controller 130 determines that the first fan driving signal SD_FAN1 is converted into the second fan driving signal SD_FAN2 at a time point t1, then in step S230, the controller 130 determines whether a predetermined instruction DI of the control signal SC is received. In step S230, the controller 130 performs identification on a waveform of the control signal SC after the time point t1. When the controller 130 identifies that part of the waveform of the control signal SC matches a waveform of the predetermined instruction DI at a time point t2, in step S240, the controller 130 separates the third fan driving signal SD_FAN3 and the light-emitting driving signal string SD_LG from the second fan driving signal SD_FAN2. That is to say, the controller 130 separates the third fan driving signal SD_FAN3 and the light-emitting driving signal string SD_LG from the second fan driving signal SD_FAN2 at the time point t2.

In this embodiment, the second fan driving signal SD_FAN2 is a driving signal combined with a plurality of driving signals of different frequencies. For example, the light-emitting driving signal string SD_LG and the third fan driving signal SD_FAN3 are encoded into the second fan driving signal SD_FAN2. In this embodiment, a frequency of the light-emitting driving signal string SD_LG is obviously greater than or equal to a frequency of the third fan driving signal SD_FAN3. Specifically, the frequency (approximately several megahertz (MHz)) of the light-emitting driving signal string SD_LG is greater than or equal to 10 times the frequency of the third fan driving signal SD_FAN3 (approximately several kilohertz (kHz) to hundred kilohertz). Therefore, the controller 130 may separate the third fan driving signal SD_FAN3 and the light-emitting driving signal string SD_LG from the second fan driving signal SD_FAN2 based on the obvious frequency difference. For another example, the light-emitting driving signal string SD_LG and the third fan driving signal SD_FAN3 are encoded into the second fan driving signal SD_FAN2 based on a coding protocol (or coding rule). Therefore, the controller 130 may separate the third fan driving signal SD_FAN3 and the light-emitting driving signal string SD_LG from the second fan driving signal SD_FAN2 based on the coding protocol (or coding rule).

In step S250, the controller 130 drives the fan 110 by using the third fan driving signal SD_FAN3 and drives the light-emitting element group 120 by using the light-emitting driving signal string SD_LG. Therefore, after the time point t2, the fan 110 is driven by the third fan driving signal SD_FAN3, and the light-emitting element group 120 is driven by the light-emitting driving signal string SD_LG.

In this embodiment, after the time point t2, the light-emitting driving signal string SD_LG is separated out continuously. For example, the light-emitting driving signal string SD_LG is divided into a plurality of sections in time. Each section includes head marker data HD, driving data D1 to Dn, and bottom marker data BD. In this example, the light-emitting element LD1 identifies the light-emitting driving signal string SD_LG by the head marker data HD and provides a light signal in response to the driving data D1, the light-emitting element LD2 identifies the light-emitting driving signal string SD_LG by the head marker data HD and provides a light signal in response to the driving data D2, and so on. The bottom marker data BD indicates an end message of each section.

On the other hand, in step S230, when the controller 130 does not identify a waveform matching the predetermined instruction DI, the driving method S200 returns to step S210. In some embodiments, the second fan driving signal SD_FAN2 is maintained based on a predetermined maintaining time length. When a maintaining time length of the second fan driving signal SD_FAN2 reaches the predetermined maintaining time length, the second fan driving signal SD_FAN2 is then converted into the first fan driving signal SD_FAN1. Therefore, in step S210, the controller 130 drives the fan 110 by using the first fan driving signal SD_FAN1.

In some embodiments, between the time points t1 and t2, the controller 130 may drive the fan 110 by using the second fan driving signal SD_FAN2.

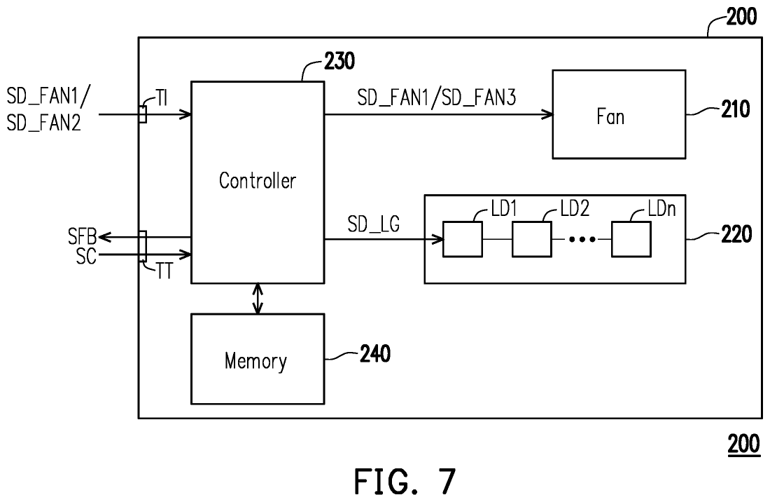

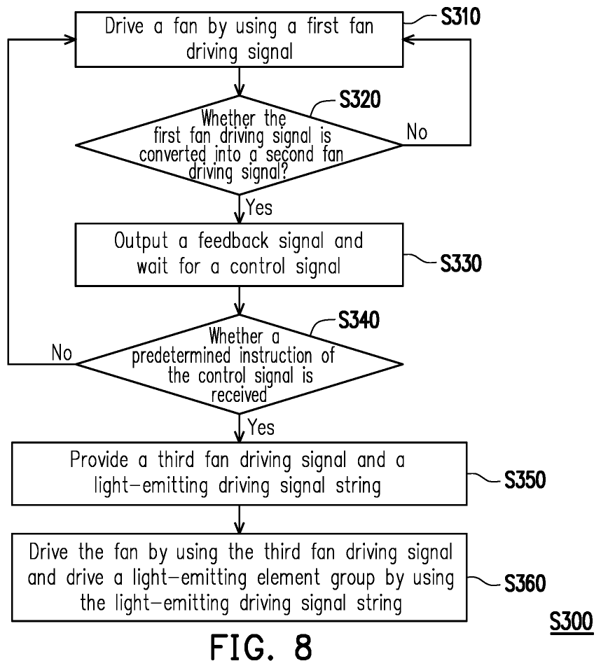

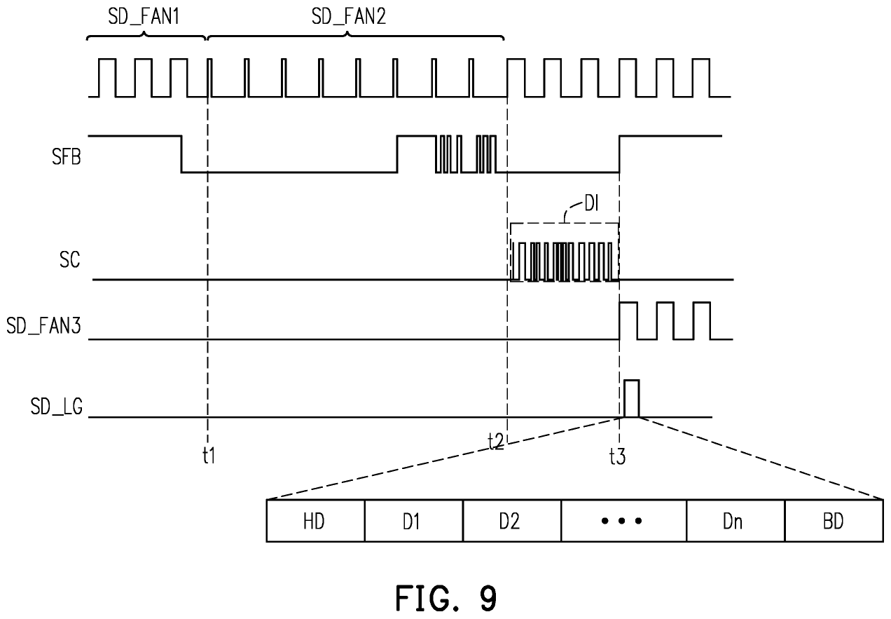

Reference may be made to FIG. 7, FIG. 8, and FIG. 9 together. FIG. 7 is a schematic diagram of an electronic device according to a second embodiment of the disclosure. FIG. 8 is a flowchart showing a third method of a driving method according to an embodiment of the disclosure. FIG. 9 is a signal timing diagram according to the second embodiment of the disclosure. In this embodiment, an electronic device 200 includes the driving signal input terminal TI, the signal transmission terminal TT, a fan 210, a light-emitting element group 220, and a controller 230. The coupling between the fan 210, the light-emitting element group 220, and the controller 230 is roughly similar to the coupling between the fan 110, the light-emitting element group 120, and the controller 130 of FIG. 3. A driving method S300 of FIG. 8 may be applied to the electronic device 200. In step S310 of this embodiment, the controller 230 drives the fan 210 by using the first fan driving signal SD_FAN1. In step S320, the controller 230 determines whether the first fan driving signal SD_FAN1 is converted into the second fan driving signal SD_FAN2. In step S320, if the controller 230 determines that the first fan driving signal SD_FAN1 is not converted into the second fan driving signal SD_FAN2, the driving method S300 returns to step S310.

On the other hand, in step S320, if the controller 230 determines that the first fan driving signal SD_FAN1 is converted into the second fan driving signal SD_FAN2 at the time point t1, then in step S330, the controller 230 outputs a feedback signal SFB. That is to say, the controller 230 outputs the feedback signal SFB through the signal transmission terminal TT during a time interval when the second fan driving signal SD_FAN2 is received. The feedback signal SFB may include operating parameters, such as an operating duration, a rotation speed, or other parameters of the fan 210. Besides, after outputting the feedback signal SFB, the controller 230 waits for the control signal SC. Therefore, the controller 230 outputs the feedback signal SFB through the signal transmission terminal TT and receives the control signal SC through the signal transmission terminal TT. The signal transmission terminal TT of this embodiment is a bidirectional transmission terminal.

For example, the control signal SC may be provided by a signal generator (not shown). The signal generator may be connected to the controller 230 through the signal transmission terminal TT. Therefore, the signal generator may receive the feedback signal SFB and provide the control signal SC in response to the feedback signal SFB. In this example, the signal generator may be disposed outside the electronic device 200. In this example, the signal generator is, for example, a central processing unit, or any other programmable general-purpose or special-purpose microprocessor, digital signal processor, programmable controller, application-specific integrated circuit, programmable logic device, or other similar devices or a combination of these devices, into which computer programs may be loaded and executed.

In this embodiment, a duty cycle of the first fan driving signal SD_FAN1 is controlled within a first duty cycle range. The first duty cycle range is, for example, a predetermined duty cycle range of the fan 210 in normal operation. Similarly, a duty cycle of the third fan driving signal SD_FAN3 is also controlled within the first duty cycle range. A duty cycle of the second fan driving signal SD_FAN2 is controlled within a second duty cycle range. Besides, the second duty cycle range are not overlapped with the first duty cycle range. For example, the first duty cycle range may be set to 20% to 80%. The second duty cycle range may be set to 81% to 100%. For another example, the first duty cycle range may be set to 20% to 80%. The second duty cycle range may be set to 5% to 15%. Therefore, the controller 230 may determine whether the first fan driving signal SD_FAN1 is converted into the second fan driving signal SD_FAN2 by a change in range of the duty cycle. In this embodiment, the duty cycle of the second fan driving signal SD_FAN2 is, for example, 10% (but the disclosure is not limited thereto).

In step S340, the controller 230 determines whether the predetermined instruction DI of the control signal SC is received. The controller 230 starts receiving the control signal SC at the time point t2, and identifies the waveform of the control signal SC after the time point t2. When the controller 130 identifies that part of the waveform of the control signal SC matches the waveform of the predetermined instruction DI at a time point t3, in step S350, the controller 230 provides the third fan driving signal SD_FAN3 and the light-emitting driving signal string SD_LG. In step S360, the controller 230 drives the fan 210 by using the third fan driving signal SD_FAN3 and drives the light-emitting element group 220 by using the light-emitting driving signal string SD_LG. Therefore, at the time point t3, the fan 210 is driven by the third fan driving signal SD_FAN3, and the light-emitting element group 220 is driven by the light-emitting driving signal string SD_LG. In this embodiment, the third fan driving signal SD_FAN3 is provided at the time point t3 or after the time point t3.

In some embodiments, based on the data structure of the predetermined instruction DI, the controller 230 may provide the third fan driving signal SD_FAN3 when part of the predetermined instruction DI (e.g., the head marker data of the predetermined instruction DI) of the control signal SC is received. That is to say, in some embodiments, the third fan driving signal SD_FAN3 may be provided between the time point t2 and the time point t3.

In this embodiment, the electronic device 200 also includes a memory 240. The memory 240 may be configured to store the light-emitting driving signal string SD_LG and the third fan driving signal SD_FAN3 corresponding to the predetermined instruction DI. Therefore, in step S350, the controller 230 provides the light-emitting driving signal string SD_LG and the third fan driving signal SD_FAN3 stored in the memory 240 based on the predetermined instruction DI. In this embodiment, the memory 240 is disposed outside the controller 230. In some embodiments, the memory 240 may be disposed inside the controller 230. The configuration of the memory 240 of the disclosure is not limited to this embodiment.

Returning to step S340, on the other hand, in step S340, when the controller 230 does not identify a waveform matching the predetermined instruction DI, the driving method S300 returns to step S310. In this embodiment, a cycle quantity of the second fan driving signal SD_FAN2 is controlled at a predetermined cycle quantity. When a cycle of the second fan driving signal SD_FAN2 reaches the predetermined cycle quantity (e.g., the predetermined cycle quantity is equal to 8, but the disclosure not limited thereto), provision of the second fan driving signal SD_FAN2 is stopped. In this embodiment, the second fan driving signal SD_FAN2 may be converted into the first fan driving signal SD_FAN1 or a signal of another waveform.

In summary of the foregoing, in the disclosure, the electronic device is configured to receive the first fan driving signal through the driving signal input terminal. When the first fan driving signal is converted into the second fan driving signal and the control signal is received through the signal transmission terminal, the electronic device is configured to provide the third fan driving signal to control the operation of the fan and provide the light-emitting driving signal string. Therefore, the electronic device can drive the fan and the light-emitting element group by using merely the signals received through the driving signal input terminal and the signal transmission terminal. In this way, in the electronic device and the driving method, the number of input terminals of the electronic device can be reduced, thereby reducing the size of the electronic device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device, comprising:
a driving signal input terminal;
a signal transmission terminal;
a fan;
a light-emitting element group configured to operate in response to a light-emitting driving signal string; and
a controller coupled to the fan and the light-emitting element group and being configured to:
receive a first fan driving signal through the driving signal input terminal and drive the fan by using the first fan driving signal, and
provide a third fan driving signal to control an operation of the fan and provide the light-emitting driving signal string based on a control signal when the first fan driving signal is converted into a second fan driving signal and the control signal is received through the signal transmission terminal.

2. The electronic device according to claim 1, wherein the control signal comprises a predetermined instruction, wherein the controller is further configured to:
separate the third fan driving signal and the light-emitting driving signal string from the second fan driving signal when the predetermined instruction is received during a time interval when the second fan driving signal is received.

3. The electronic device according to claim 2, wherein the light-emitting driving signal string and the third fan driving signal are encoded into the second fan driving signal.

4. The electronic device according to claim 2, wherein a frequency of the light-emitting driving signal string is greater than or equal to 10 times a frequency of the third fan driving signal.

5. The electronic device according to claim 1, wherein the controller is further configured to:
output a feedback signal through the signal transmission terminal during a time interval when the second fan driving signal is received, and wait for the control signal, and
provide the third fan driving signal and provide the light-emitting driving signal string when a predetermined instruction of the control signal is received.

6. The electronic device according to claim 5, further comprising:
a memory configured to store the light-emitting driving signal string and the third fan driving signal corresponding to the predetermined instruction.

7. The electronic device according to claim 5, wherein
a duty cycle of the first fan driving signal and a duty cycle of the third fan driving signal are controlled within a first duty cycle range,
a duty cycle of the second fan driving signal is controlled within a second duty cycle range, and
the second duty cycle range are not overlapped with the first duty cycle range.

8. The electronic device according to claim 5, wherein
a cycle quantity of the second fan driving signal is controlled at a predetermined cycle quantity, and
provision of the second fan driving signal is stopped when a cycle of the second fan driving signal reaches the predetermined cycle quantity.

9. The electronic device according to claim 1, wherein
the light-emitting element group comprises a plurality of light-emitting elements connected in series with each other, and
the light-emitting driving signal string comprises a plurality of light-emitting driving signals corresponding to the plurality of light-emitting elements.

10. A driving method for an electronic device, wherein the electronic device comprises a driving signal input terminal, a signal transmission terminal, a fan, and a light-emitting element group, wherein the driving method comprises:
receiving a first fan driving signal through the driving signal input terminal and driving the fan by using the first fan driving signal, and
providing a third fan driving signal to control an operation of the fan and providing a light-emitting driving signal string based on a control signal when the first fan driving signal is converted into a second fan driving signal and the control signal is received through the signal transmission terminal.

11. The driving method according to claim 10, wherein the control signal comprises a predetermined instruction, wherein the step of providing the third fan driving signal to control the operation of the fan and providing the light-emitting driving signal string when the first fan driving signal is converted into the second fan driving signal and the control signal is received through the signal transmission terminal comprises:
separating the third fan driving signal and the light-emitting driving signal string from the second fan driving signal when the predetermined instruction is received during a time interval when the second fan driving signal is received.

12. The driving method according to claim 11, further comprising:
encoding the light-emitting driving signal string and the third fan driving signal into the second fan driving signal.

13. The driving method according to claim 11, wherein a frequency of the light-emitting driving signal string is greater than or equal to 10 times a frequency of the third fan driving signal.

14. The driving method according to claim 10, wherein the control signal comprises a predetermined instruction, wherein the step of providing the third fan driving signal to control the operation of the fan and providing the light-emitting driving signal string when the first fan driving signal is converted into the second fan driving signal and the control signal is received through the signal transmission terminal comprises:
outputting a feedback signal through the signal transmission terminal during a time interval when the second fan driving signal is received, and waiting for the control signal, and
providing the third fan driving signal and providing the light-emitting driving signal string when the predetermined instruction of the control signal is received.

15. The driving method according to claim 14, wherein the control signal comprises a memory, wherein the memory is configured to store the light-emitting driving signal string and the third fan driving signal corresponding to the predetermined instruction, wherein the step of providing the third fan driving signal and providing the light-emitting driving signal string when the predetermined instruction of the control signal is received comprises:
providing the light-emitting driving signal string and the third fan driving signal stored in the memory based on the predetermined instruction when the predetermined instruction is received.

16. The driving method according to claim 14, wherein
a duty cycle of the first fan driving signal and a duty cycle of the third fan driving signal are controlled within a first duty cycle range,
a duty cycle of the second fan driving signal is controlled within a second duty cycle range, and
the second duty cycle range are not overlapped with the first duty cycle range.

17. The driving method according to claim 14, further comprising:
controlling a cycle quantity of the second fan driving signal at a predetermined cycle quantity, and
stopping provision of the second fan driving signal when a cycle of the second fan driving signal reaches the predetermined cycle quantity.
